(19) United States
(12) Patent Application Publication
(10) Pub. No.: US 2025/0216601 A1
(43) Pub. Date: Jul. 3, 2025

(54) SILICON PHOTONIC INTEGRATED CIRCUITS WITH LOCALIZED THICK BURIED INSULATOR

(71) Applicant: Intel Corporation, Santa Clara, CA (US)

(72) Inventors: Harel Frish, Albuquerque, NM (US); Banaful Paul, Rio Rancho, NM (US); Kelly Magruder, Albuquerque, NM (US); Eddie Bononcini, Corrales, NM (US); John Heck, Berkeley, CA (US)

(73) Assignee: Intel Corporation, Santa Clara, CA (US)

(21) Appl. No.: 18/399,503

(22) Filed: Dec. 28, 2023

(51) Int. Cl. G02B 6/12; G02B 6/136

(52) U.S. Cl. CPC G02B 6/12004; G02B 6/136; G02B 2006/12061; G02B 2006/12121

(57) ABSTRACT

A silicon photonic (SiPh) integrated circuit on a substrate comprising a buried insulator layer of varying thickness between an optical waveguide and an underlying silicon layer. The insulator layer has a first thickness under a first length of the waveguide and a second, greater, thickness under a second length of the waveguide. Buried insulator layer thickness may be thinner where an optical mode is to be more confined during operation of the SiPh IC, and buried insulator layer thickness may be greater within localized regions where optical mode is to expand during operation of the SiPh IC. Accordingly, a transfer of optical energy to an underlying silicon layer of the substrate may be curtailed within one substrate region without impeding the transfer of thermal energy to the underlying silicon layer within another substrate region.

### BACKGROUND

Photonic integrated circuits (PICs) are increasingly important in high-performance computing, data center, and cloud computing applications. The use of silicon in photonics (SiPh), enables high-volume, low-cost and highly integrated PICs.

SiPh PICs may include optical waveguides fabricated on substrates comprising silicon. Depending on their design, the waveguides may closely confine an optical mode or allow for mode expansion. As an optical mode expands, mode leakage into a silicon substrate material becomes more significant and can lead to optical power losses that detrimentally impact PIC performance. Accordingly, SiPh PIC architectures and techniques improving optical isolation of substrate material would be commercially advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a flow diagram of methods for fabricating a PIC with a localized thick buried insulator, in accordance with some embodiments;

FIG. 2 is a cross-sectional view through a region of a PIC substrate, in accordance with some embodiments;

FIG. 3A is a plan view of patterning a region of a PIC substrate where thick buried insulator is to be located, in accordance with some embodiments;

FIG. 3B is a cross-sectional profile view of the region of a PIC substrate shown in FIG. 3A, in accordance with some embodiments;

FIG. 4A is a plan view of patterning features into a region of a PIC substrate where thick buried insulator is to be located, in accordance with some embodiments;

FIG. 4B is a cross-sectional profile view of the region of a PIC substrate shown in FIG. 4A, in accordance with some embodiments;

FIG. 5A is a plan view of thermally oxidizing a features of a PIC substrate into insulator material, in accordance with some embodiments;

FIG. 5B is a cross-sectional profile view of the region of a PIC substrate shown in FIG. 5A, in accordance with some embodiments;

FIG. 6 is a cross-sectional view of forming an insulator material over an oxidized region of a PIC substrate, in accordance with some embodiments;

FIG. 7A is a plan view of a planarized a PIC substrate that includes thick buried insulator, in accordance with some embodiments;

FIG. 7B is a cross-sectional profile view of the region of a PIC substrate shown in FIG. 7A, in accordance with some embodiments;

FIG. 8A is a plan view of lengths of an optical waveguide formed over regions of a PIC, in accordance with some embodiments;

FIG. 8B is a cross-sectional profile view of the regions of a PIC shown in FIG. 8A, in accordance with some embodiments;

FIG. 9A is a plan view of an output coupler assembled over a first region of a PIC, in accordance with some embodiments;

FIG. 9B is a cross-sectional profile view the assembly shown in FIG. 9A, in accordance with some embodiments;

FIG. 10A is a plan view of a hybrid silicon laser within a second region of the PIC shown in FIG. 9A, in accordance with some embodiments;

FIG. 10B is a cross-sectional profile view of the region of the PIC shown in FIG. 10A, in accordance with some embodiments;

FIG. 11 illustrates a computing platform comprising a silicon PIC including a localized thick buried insulator, in accordance with some embodiments; and

FIG. 12 is a functional block diagram of an electronic computing device, that may implement one or more of the components of the computing platform illustrated in FIG. 11, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

A silicon photonic (SiPh) device on a substrate comprising a buried insulator layer between one or more optical waveguides and an underlying silicon layer is described below. The SiPh device may be fabricated upon a semiconductor-on-insulator (SOI) substrate, for example. The SOI substrate may have a substantially planar buried insulator layer of a substantially uniform first thickness between a top silicon layer and a bottom silicon layer. This first thickness of the buried insulator may be minimal, for example to reduce thermal resistance of the buried insulator, under a first length of one or more of the optical waveguides where an optical mode is adequately confined by the first buried insulator thickness that optical coupling into the bottom silicon layer is insignificant.

A buried insulator of a second, greater, thickness may be formed within one or more localized regions of the substrate and a second length of the optical waveguides may extend over the thicker buried insulator. The second buried insulator thickness may be located wherever an optical mode will expand when propagated within a waveguide during operation of the SiPh IC. Through the practice of embodiments herein, losses of optical energy to an underlying silicon layer in first regions of the substrate may be curtailed without significantly impeding the transfer of thermal energy to the underlying silicon layer in other regions of substrate.

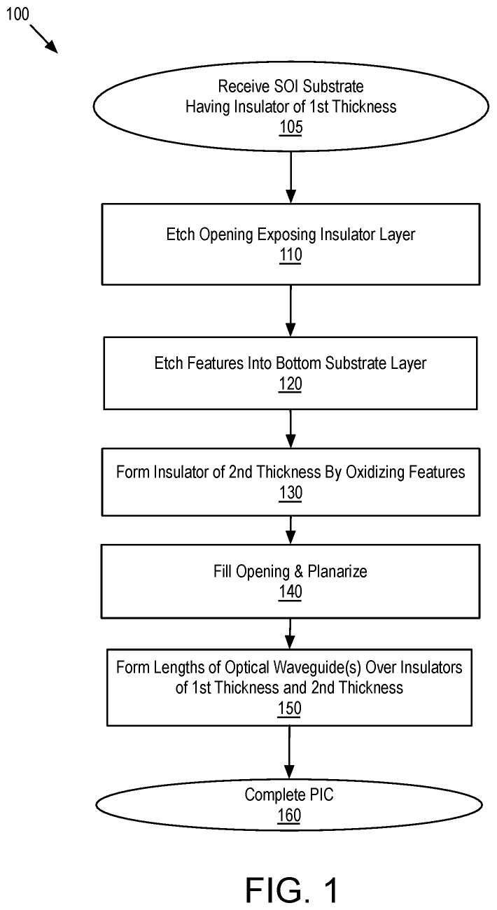

FIG. 1 is a flow diagram of methods 100 for fabricating a PIC with localized thick buried insulator(s), in accordance with some embodiments. Methods 100 may be practiced to fabricate a silicon-based PIC device having one or more of the structural attributes described herein. Methods 100 may also be practiced to fabricate other PIC devices that face similar concurrent self-heating and substrate coupling challenges. In some exemplary embodiments, methods 100 integrate an optical output coupler within one or more photonic integrated circuits (PICs), and more specifically within a silicon photonic chip. In some further embodiments, methods 100 integrate the optical output coupler and a hybrid-silicon laser within a photonic integrated circuit, and more specifically with one silicon photonic chip. Although examples are further described in the context of SiPh implementations, the exemplary PIC substrate architectures may also be implemented in alternative substrate technologies (e.g., exclusively III-V) without departing from the principles disclosed herein.

Methods 100 begin at input 105 where a substrate is received. In exemplary embodiments, the substrate received includes silicon and a buried insulator layer, for example between a top (front) side silicon layer and another silicon layer on a bottom (back) side of the insulator layer. The buried insulator layer may be fabricated upstream of methods 100, for example with any wafer bonding process, or other buried insulator process.

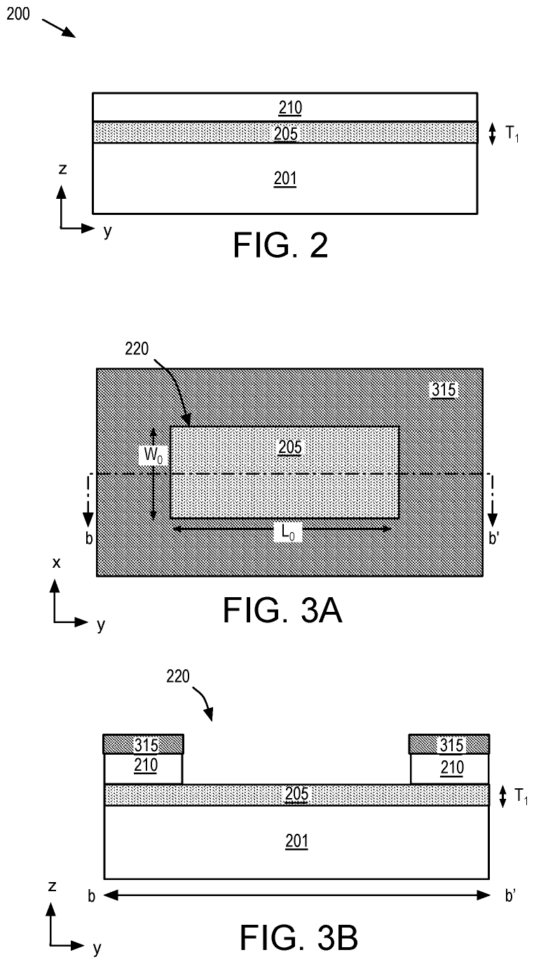

FIG. 2 is a plan view of a monolithic silicon PIC substrate 200, in accordance with some embodiments. In some examples, substrate 200 has a diameter of 300 mm, but may be of any dimension(s). Substrate 200 includes a substrate material layer 210. In exemplary embodiments substrate material layer 210 comprises substantially monocrystalline silicon. As further illustrated in FIG. 2, substrate material layer 210 is a top layer of a SOI substrate material stack further comprising a buried insulator material layer 205. In exemplary embodiments, where substrate material layer 210 is substantially pure silicon, insulator material layer 205 is advantageously predominantly silicon and oxygen and may be essentially pure silicon dioxide (e.g., SiO₂). One or more additional substrate material layers may be under, or on a back side of, insulator material layer 205. In the example illustrated in FIG. 2, buried insulator material layer 205 is between substrate material layer 210 and a bottom substrate material layer 201. In some embodiments where substrate material layer 210 is substantially monocrystalline silicon, substrate material layer 201 is also substantially monocrystalline silicon. Buried insulator material layer 205 has a thickness T₁, which may vary with implementation. Heat transfer from a PIC through substrate 200 can be significantly impeded by buried insulator material layer as insulator material has much lower thermal conductivity than substrate material layers 201 and 210. Accordingly, thickness T₁ may be minimized for highest substrate heat transfer rates. In some embodiments, thickness T₁ is less than 4 μm, advantageously less than 3 μm, more advantageously less than 2 μm, and in some examples around 1 μm.

Returning to FIG. 1, methods 100 continue at block 110 where an opening or window is patterned into the PIC substrate, removing at least the upper material layer to expose a region of the buried insulator layer. As described further below, the opening formed at block 110 defines a localized region where a thicker buried insulator is to be formed. One or more masking and etching processes may be practiced at block 110. In some exemplary embodiments, masking includes deposition of a thin film having a composition and thickness suitable as an oxidation barrier. This thin film is then patterned as a hardmask during one or more etch processes further removing at least the upper substrate material layer. In exemplary embodiments, a lithographic patterning process defines a mask pattern and an anisotropic etch process transfers the mask pattern into the substrate material.

FIG. 3A is a plan view showing the patterning of a region 220 in PIC substrate 200, in accordance with some embodiments. FIG. 3B is a cross-sectional profile view of the PIC substrate 200 along the b-b′ line passing through region 220 as demarked in FIG. 3A. Although region 220 may have any dimensions, in some example region 220 has a length L₀ of at least 30 μm and a width W₀ of less than 20 μm. In this example, hardmask material layer 315 is over regions of PIC substrate 200 outside of, or at a periphery of, region 220. In some embodiments hardmask material layer 315 comprises a dielectric material, and in advantageous embodiments is predominantly silicon and nitrogen (e.g., Si₃N₄). Hardmask material layer 315 may, in some other examples, include oxygen (e.g., SiON or SiO).

Returning to FIG. 1, methods 100 continue at block 120 where features are etched into the bottom substrate layer within the opening that was defined at block 110. One or more masking and etching processes may be practiced at block 120 to form features, such as a 1D grating of fins or a 2D grating of pillars, at a predetermined feature pitch and spacing. The features may be etched to a depth that may vary with implementation. In exemplary embodiments, a lithographic patterning process defines a mask pattern and an anisotropic etch process transfers the mask pattern into the substrate material layers. Following the etch process, the mask pattern may be subsequently stripped.

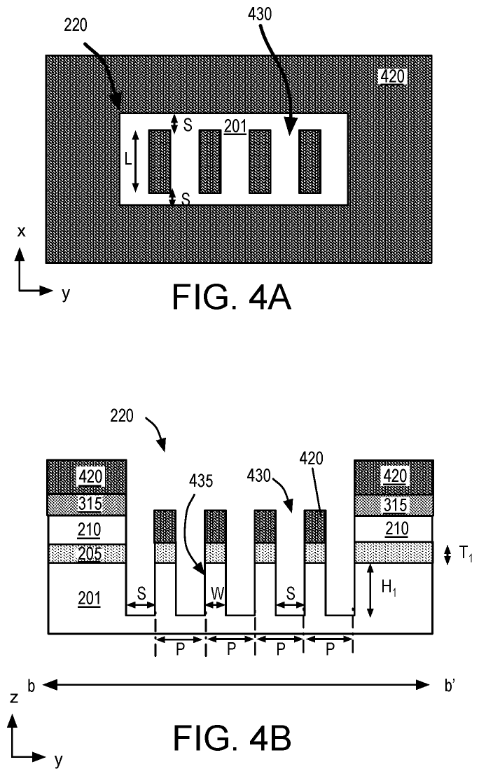

FIG. 4A is a plan view of PIC substrate 200 following feature patterning, in accordance with some embodiments. FIG. 4B is a cross-sectional profile view of PIC substrate 200 along the b-b′ line shown in FIG. 4A. In this example, a mask material 420 is over hardmask material layer 315 outside of region 220. Within region 220, mask material 420 is over insulator layer 205 and features 435 of substrate material layer 201 have be patterned by etching trenches 430 between adjacent substrate material features 435. Substrate material features 435 have a height H₁ below a substantially planar interface with insulator layer 205. In some exemplary embodiments, feature height H₁ is at least 1 μm, advantageously at least 2 μm and more advantageously 4 μm, or more. In this example substrate material features 435 comprise lines or fins of a fixed width W and fixed space S for a fixed grating pitch P. In the illustrated example, the fins have a length L along the x-dimension (FIG. 4A) that spans a majority of region 220 in the x-dimension. Length L may be selected so fin ends are spaced apart from a perimeter of region 220 by approximately space S. The number of substrate material features 435 may be predetermined so that intervening trenches 430 of space S substantially span the y-dimension of region 220.

Returning to FIG. 1, methods 100 continue at block 130 where an insulator material of a second thickness is formed by oxidizing the substrate features that were defined at block 120. The oxidation process may be any thermal oxidation and/or low plasma oxidation process. In exemplary embodiments, the oxidation process substantially converts an entirety of the substrate features into an oxide of the substrate material. For embodiments where the substrate material is substantially pure silicon, the oxidation process may convert the substrate features into substantially pure silicon dioxide. Conditions and duration of the thermal oxidation process may be defined based on the substrate feature width, for example to ensure at least one-half the feature width is oxidized. Because the oxidation occurs over the entire height of the features, a thickness of the resulting insulator material is controlled by the feature height defined in block 120 so that an oxidation process capable of oxidizing approximately one-half the feature width may form an insulator material of any thickness below a surface of the PIC substrate. In advantageous embodiments, substrate feature pitch is selected so that the thick insulator material formed at block 130 expands to substantially fill spaces between oxidized features so that the insulator material occupies the area of the opening defined at block 110. The width and pitch of silicon features may be determined, for example, based on the oxidation of silicon inducing a volumetric expansion of approximately 2.2:1 (SiO₂:Si).

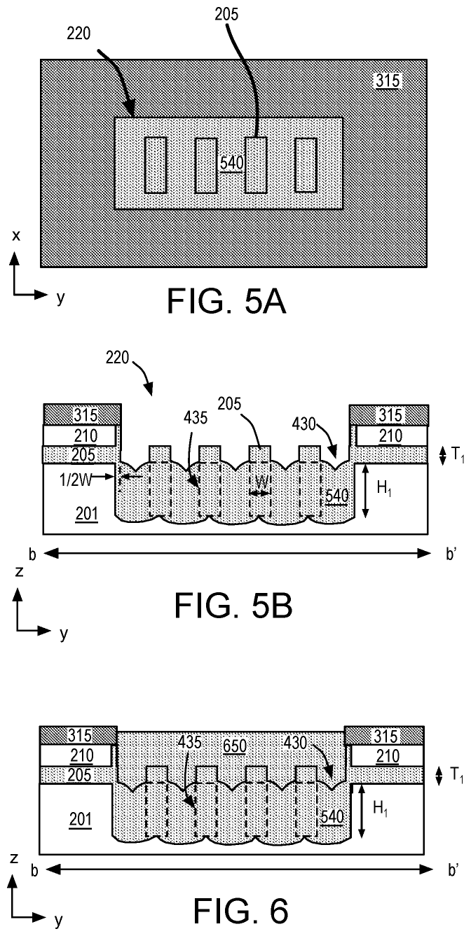

FIG. 5A and FIG. 5B are plan and sectional views of PIC substrate 200 following the oxidation of substrate material features 435, in accordance with some embodiments. In FIG. 5B, substrate material features 435 are illustrated in dashed line to emphasize features 435 have been substantially converted into insulator material 540. As shown, insulator material 540 has expanded to substantially fill trenches 430 along height H₁. In addition to substantially oxidizing substrate material features 435, the oxidation process converts a thickness of substrate material layer 201 both at a bottom of trenches 430 and along a perimeter sidewall of region 220. Insulator material 540 therefore expands laterally under insulator layer 205, for example by at least one-half width W. A similar sidewall thickness of substrate material layer 210 may also be oxidized.

Returning to FIG. 1, methods 100 continue at block 140 where openings in the PIC substrate containing the thick insulator are backfilled with additional dielectric material and planarized with the surrounding surface of the PIC substrate. One or more dielectric deposition processes, such as a chemical vapor deposition (CVD) or a flowable oxide deposition process, may be practiced at block 140. Dielectric material deposited at block 140 may have any composition suitable as a supplement to the underlying insulator material formed at block 130. In some embodiments, a dielectric material comprising primary silicon and oxygen (i.e., SiOₓ) is deposited at block 140. The dielectric material deposited at block 140 may have one or more impurities, such as carbon, hydrogen, or nitrogen at a concentration higher than that of the underlying insulator material. Film stress within the dielectric material deposited at block 140 may also be significantly different (e.g., greater) than that of the underlying insulator material.

Dielectric material may be deposited to any thickness, but in some examples is deposited to a thickness sufficient to permit planarization of the opening with a surrounding surface of the PIC substrate. After planarization, the hardmask material may be removed from the surrounding surface of the PIC substrate. The PIC substrate then includes a substantially contiguous region where the buried insulator is of a first thickness surrounding one or more localized regions where a thicker insulator is buried within a trench or well in the PIC substrate.

FIG. 6 is a cross-sectional view of PIC substrate 200 following deposition of additional insulator material 650 and planarization of any overburden to expose hardmask material layer 315. For some exemplary embodiments where substrate material 201 is substantially pure silicon and insulator material 540 is substantially pure silicon dioxide, insulator material 650 is also primarily silicon and oxygen (e.g., SiO₂). Accordingly, the interface between insulator materials 540 and 650 illustrated in FIG. 6 may not be readily evident in a SEM image unless a staining process is able decorate the different insulator materials, for example because of different levels of film stress.

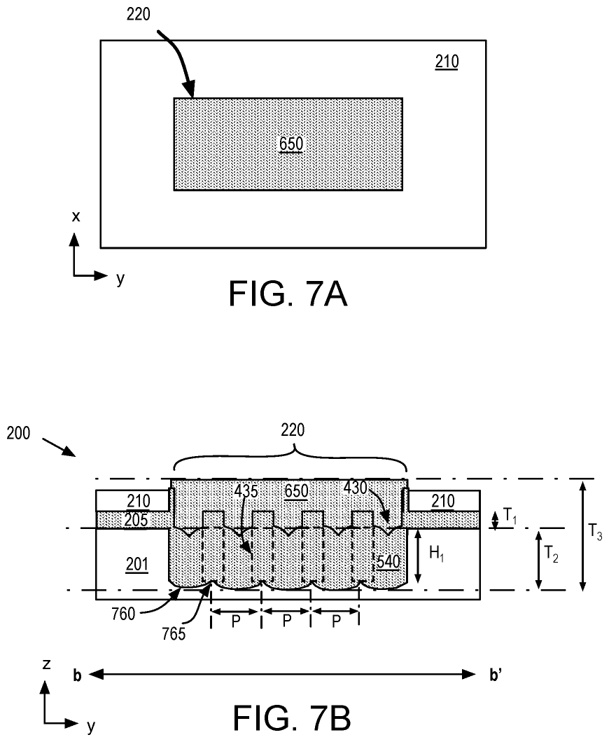

FIG. 7A and FIG. 7B are plan and cross-sectional views of PIC substrate 200 following removal of hardmask material 315, in accordance with some embodiments. As shown, within region 220 there is insulator material having a total thickness T₃, which comprises a substrate oxidation product having thickness T₂ embedded within substrate material 201, and a capping insulator material 650 making up the remainder of thickness T₃. Thickness T₂ is somewhat greater than feature height H₁ due to oxidation of substrate material at the bottom of trenches 430. In exemplary embodiments, thickness T₃ is at least twice thickness T₁, advantageously at least three times thickness T₁, and more advantageously over four times thickness T₁. In some examples where thickness T₁ is approximately 1 μm, thickness T₂ is 4-10 μm and thickness T₃ is 6-12 μm.

In some embodiments, thickness T₂ (and therefore total thickness T₃) may vary periodically between peaks 765 and valleys 760 over a length (e.g., y-dimension) of region 220. The illustrated corrugated interface between substrate material 201 and insulator material 540 varies as a function of pitch P and is indicative of the feature oxidation technique for embodiments of methods 100 (FIG. 1) where fins are patterned at block 130. For such embodiments, thickness T₂ may be substantially constant over any orthogonal width (e.g., x-dimension) of region 220. For alternative embodiments where pillars are patterned at block 130, thickness T₂ may instead vary over both length (e.g., y-dimension) and width (e.g., x-dimension) of region 220. For such embodiments, the illustrated interface between substrate material 201 and insulator material 540 may vary as a function of feature pitch in two orthogonal dimensions. The interface of substrate material 210 at insulator material 540 is then a convoluted surface like an egg crate.

Returning to FIG. 1, methods 100 continue with the fabrication of one or more optical waveguides over the PIC substrate surface. The optical waveguides may have any suitable architecture, such as, but not limited to, a substantially planar ridge waveguide. Lengths of an optical waveguide over a PIC substrate region where buried insulator is thinner may be fabricated from a region of the upper substrate material layer. Lengths of an optical waveguide over a PIC substrate region where buried insulator is thicker may be fabricated from one or more materials other than the upper substrate material layer, which was removed from this PIC substrate region. The various lengths of waveguides spanning the different buried insulator thickness may be of a same optical waveguide (e.g., at different ends) within a PIC, or may be lengths within entirely different waveguides fabricated within a PIC.

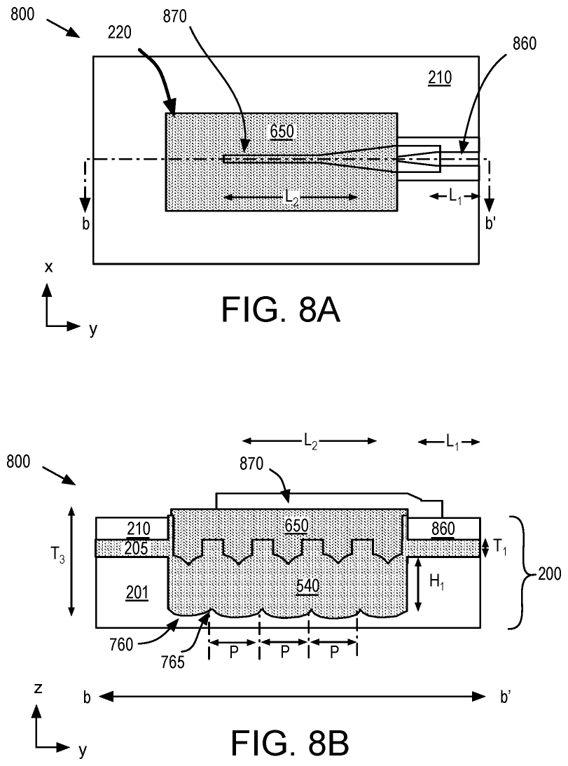

FIG. 8A and FIG. 8B illustrate plan and sectional views of a PIC 800 that includes optical waveguide lengths L₁ and L₂, which have been fabricated over regions of PIC substrate 200, in accordance with some embodiments. An optical waveguide 860 comprising optical waveguide length L₁ spans a region of PIC substrate 200 external of region 220. Accordingly, optical waveguide length L₁ is over insulator material layer 205 having thickness T₁. Waveguide 860 has been patterned from substrate material layer 210 and may therefore be substantially pure silicon, for example. Waveguide 860 is a planar ridge architecture having a substantially constant transverse width (e.g., in x-dimension) over a longitudinal length (e.g., in y-dimension) before tapering down with increasing proximity to region 220. In some exemplary silicon waveguide embodiments, waveguide width outside of a tapered region is in the range of 150 nm to 1 μm. A similar range is also applicable to waveguide z-height (FIG. 8B). As shown in FIG. 8A, sidewalls of waveguide 860 are defined by trenches extending through a partial thickness of substrate material layer 210 (i.e., insulator material layer 205 is not exposed over length L₁). During operation of PIC 800, one or more optical modes propagating through waveguide length L₁, as guided by waveguide 860, are adequately confined by insulator material 205 (e.g., as a bottom cladding) so that the modes do not significantly couple into substrate material 201.

An optical waveguide 870 comprising optical waveguide length L₂ spans a region of PIC substrate 200 within region 220. Optical waveguide length L₂ is therefore over a thick insulator comprising insulator material layer 540 (and insulator material 650) having the total thickness T₃. Waveguide 870 is patterned within a thin film material layer that is over (and may be in contact with) insulator material 650. Although the width of waveguide 870 may vary, in some exemplary embodiments the width is in the range of 100 nm to 500 nm. In the illustrated example, corrugation peaks 765 and valleys 760 are approximately orthogonal to longitudinal waveguide length L₁. A portion of waveguide 870 overlaps a portion of waveguide 860, and during operation, an optical mode may be vertically coupled through the overlap portions to propagate between the two waveguide lengths L₁ and L₂.

Although the composition of waveguide 870 may vary, in some exemplary embodiments waveguide 870 comprises primarily silicon and nitrogen (e.g., Si₃N₄). During operation of PIC 800, one or more optical modes propagating through waveguide length L₂ as guided by waveguide 870 may expand more deeply into PIC substrate 200 and would optically couple into substrate material 201 (e.g., through evanescence) if not for the underlying thick insulator.

Returning to FIG. 1, methods 100 end at output 160 where a PIC is completed, for example with the fabrication and/or assembly of one or more passive or active devices optically coupled to the PIC waveguides fabricated at block 150. Any passive or active optical devices may be fabricated within a PIC or assembled upon a PIC according to any technique(s) known in the art. Passive optical devices may include (de) multiplexers, grating couplers, or output couplers, for example. Active optical devices may include thermo-optical modulators, semiconductor optical amplifiers (SOAs), photodetectors or lasers, for example.

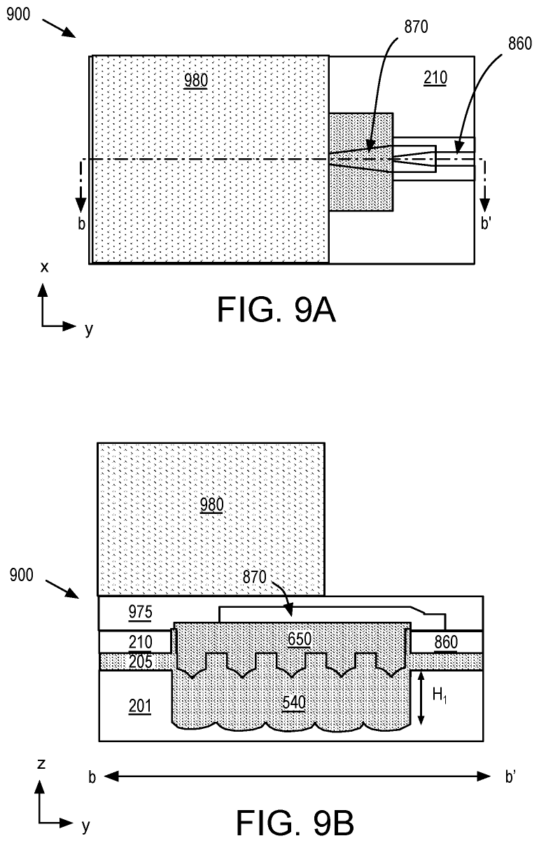

FIG. 9A and FIG. 9B illustrate plan and section views of PIC 900 further including an output coupler 980 assembled over at least a partial length of optical waveguide 870, in accordance with some embodiments. Output coupler 980 may have an alternative edge facet coupling architecture, but in the illustrated embodiment comprises a vertically coupling glass preform adhered, for example by an intervening material 975. Output coupler 980 may optically interconnect PIC 900 (through waveguides 870 and 860) to an optical source or sink external of PIC 900. For example, optical coupler 980 may interface PIC 900 to a multi-mode or single mode optical fiber core, for example. Optical coupler 980 may comprise one or more mirror facets and/or lenses to couple a mode between an x-y plane PIC 900 and a vertically or horizontally (e.g., edge) coupled fiber comprising a core surrounded by one or more cladding layers.

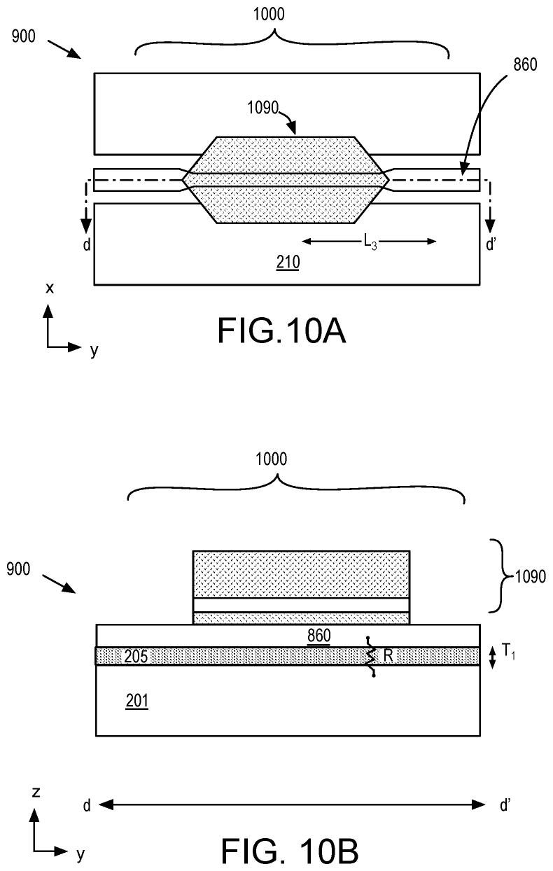

FIG. 10A and 10B illustrate a hybrid silicon laser 1000 within a second region of PIC 900, in accordance with some embodiments. Hybrid silicon laser 1000 includes another length L₃ of optical waveguide 860, which extends over a substrate region where buried insulator 205 has thickness T₁. In exemplary embodiments, waveguide length L₃ is substantially monocrystalline silicon. Over waveguide length L₃, waveguide 860 may have any suitable architecture, such as, but not limited to, a substantially planar ridge waveguide. In the illustrated example, optical waveguide 860 has a substantially constant transverse width (e.g., in x-dimension) over a longitudinal length (e.g., in y-dimension) of an active waveguide region underlying a P-i-N laser diode material stack 1090. At opposite ends of the active waveguide region, waveguide 860 tapers out to passive waveguide regions having a larger transverse width. Although the active waveguide width may vary, in some exemplary silicon waveguide embodiments the active waveguide width is in the range of 150 nm to 400 nm.

At least a region of waveguide 860 may comprise a mirror for establishing a resonant optical cavity comprising waveguide length L₃, for example according to any suitable Fabry-Perot (FP) laser architecture. Grating structures (not depicted) may be defined within passive waveguide regions according to any suitable Distributed Bragg Reflector (DBR) laser architecture. Alternatively, in a distributed Feedback (DFB) laser architecture, one or more grating structures may be located within an active waveguide region.

For laser 1000, the term “hybrid” is in reference to a P-i-N laser diode material stack 1090 comprising non-silicon (e.g., III-V) materials, which is bonded to the underlying PIC substrate comprising waveguide 860. Material stack 1090 may comprise any suitable P-i-N diode material stack, for example including quantum well (QW) or quantum dot (QD) material heterostructures between an n-type material layer and a p-type material layer. Material stack 1090 may be Group III-V crystalline alloy material (i.e., a III-V material stack), such as a GaAs/InGaAs heterostructure or InP/InGaP heterostructure, for example.

As further illustrated in FIG. 10B, insulator material 205, with thickness T₁, poses an advantageously small thermal resistance R to the transfer of heat generated within laser 1000 during operation of PIC 900. A back side laser heat dissipator (not depicted) may be in thermal contact with substrate material 201 to further transfer the heat off PIC 900. Lower thermal impedance associated with insulator thickness T₁ can therefore reduce laser self-heating and thereby reduce thermal rollover effects where laser output declines sharply as laser current increases. A benefit of reduced buried insulator thickness may therefore be realized within PIC 900, which also takes benefit of lower optical loss associated with greater insulator thickness.

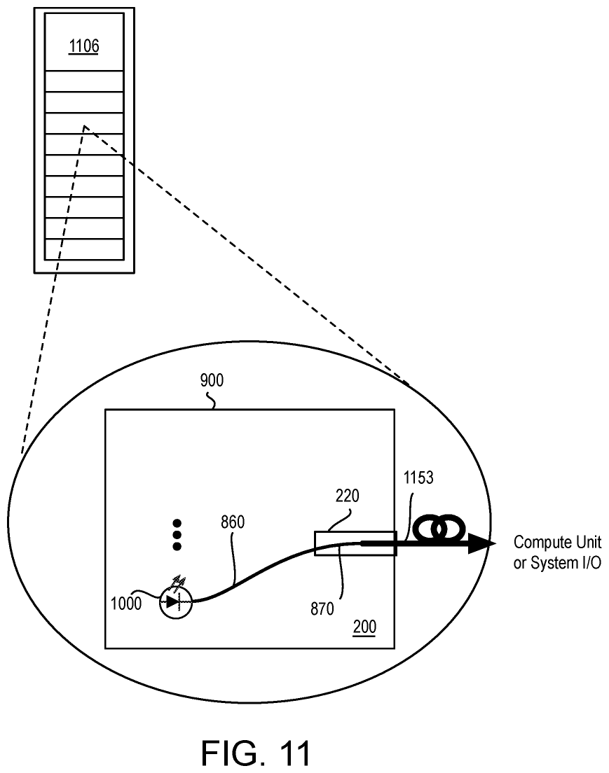

The PIC substrate structures and PICs incorporated such substrates described herein may be implemented in a wide variety of applications and platforms. FIG. 11 illustrates a data server platform 1106 employing an optical link with one or more PIC, for example comprising silicon and buried insulators of different thicknesses, as described elsewhere herein. Platform 1106 may be any commercial server, for example including any number of high-performance computing platforms or compute units networked together for electronic data processing.

As shown in an expanded view, platform 1106 includes PIC 900. PIC 900 may be one of a plurality of PICs in a multi-chip package, or a stand-alone packaged PIC. PIC 900 includes waveguide-coupled hybrid-silicon laser 1000, in accordance with some embodiments. During operation, a wavelength output by laser 1000 is propagated through waveguide 860 over a first region of substrate 200, as well as through waveguide 870 over region 220 of substrate 200. Region 220 may have any of the localized thick buried insulator attributes and/or structures described elsewhere herein. The optical beam may be coupled off-chip to an optical fiber 1153, for example through top-side coupling or edge output coupler (not depicted).

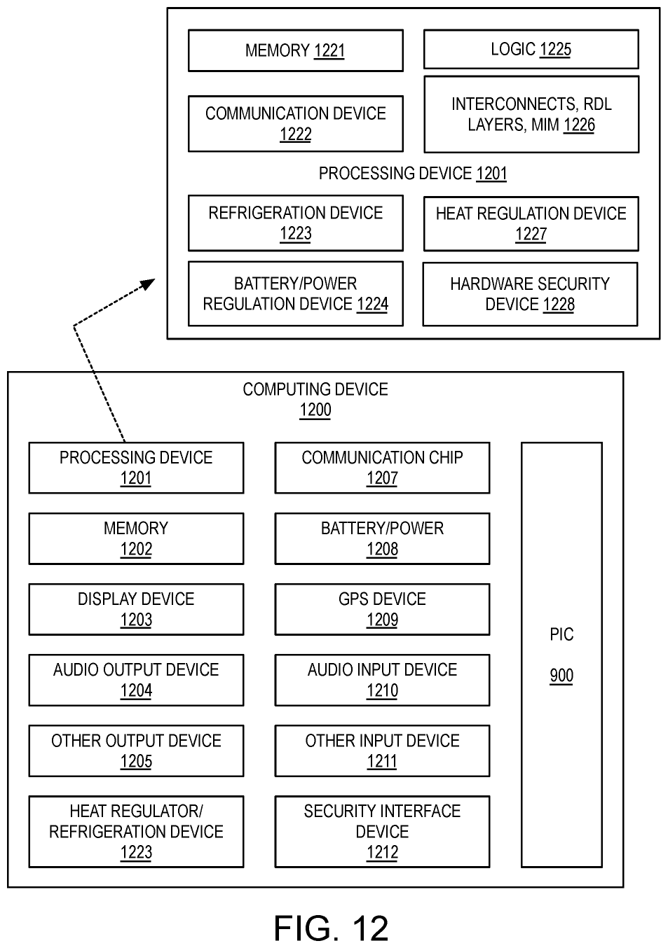

FIG. 12 is a block diagram of a computing device 1200 in accordance with some embodiments. For example, one or more components of computing device 1200 may include any of the PIC structures discussed elsewhere herein. A number of components are illustrated in FIG. 12, but any one or more of these components may be omitted or duplicated, as suitable for the application. In some embodiments, some of the components included in computing device 1200 may be attached to one or more printed circuit boards (e.g., a motherboard). In some embodiments, various ones of these components may be fabricated onto a single system-on-a-chip (SoC) die or implemented with a disintegrated plurality of chiplets or tiles packaged together. Additionally, in various embodiments, computing device 1200 may not include one or more of the components illustrated in FIG. 12, but computing device 1200 may include interface circuitry for coupling to the one or more components. For example, computing device 1200 may not include a display device 1203, but may include display device interface circuitry (e.g., a connector and driver circuitry) to which display device 1203 may be coupled.

Computing device 1200 may include a processing device 1201 (e.g., one or more processing devices). As used herein, the term processing device or processor indicates a device that processes electronic data from registers and/or memory to transform that electronic data into other electronic data that may be stored in registers and/or memory. Processing device 1201 may include a memory 1221, a communication device 1222, a refrigeration/active cooling device 1223, a battery/power regulation device 1224, logic 1225, interconnects 1226, a heat regulation device 1227, and a hardware security device 1228.

Processing device 1201 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable compute units.

Processing device 1201 may include a memory 1202, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing 1201 shares a package with memory 1202. This memory may be used as cache memory and may include embedded dynamic random-access memory (eDRAM) or spin transfer torque magnetic random-access memory (STT-M RAM).

Computing device 1200 may include a heat regulation/refrigeration device 1223. Heat regulation/refrigeration device 1223 may maintain processing device 1201 (and/or other components of computing device 1200) at a predetermined low temperature during operation. This predetermined low temperature may be any temperature discussed elsewhere herein.

In some embodiments, computing device 1200 may include a communication chip 1207 (e.g., one or more communication chips). For example, the communication chip 1207 may be configured for managing wireless communications for the transfer of data to and from computing device 1200. The term “wireless” and its derivatives may be used to describe circuits, devices, systems, methods, techniques, communications channels, etc., that may communicate data through the use of modulated electromagnetic radiation through a nonsolid medium.

Computing device 1200 includes PIC 900, for example having one of the photonic integrated WDM source circuit architectures described herein. PIC 900 may facilitate communication between one or more instances of processing device 1201 and/or one or more instances of memory 1202.

Computing device 1200 may include battery/power circuitry 1208. Battery/power circuitry 1208 may include one or more energy storage devices (e.g., batteries or capacitors) and/or circuitry for coupling components of computing device 1200 to an energy source separate from computing device 1200 (e.g., AC line power).

Computing device 1200 may include a display device 1203 (or corresponding interface circuitry, as discussed above). Display device 1203 may include any visual indicators, such as a heads-up display, a computer monitor, a projector, a touchscreen display, a liquid crystal display (LCD), a light-emitting diode display, or a flat panel display, for example.

Computing device 1200 may include an audio output device 1204 (or corresponding interface circuitry, as discussed above). Audio output device 1204 may include any device that generates an audible indicator, such as speakers, headsets, or earbuds, for example.

Computing device 1200 may include an audio input device 1210 (or corresponding interface circuitry, as discussed above). Audio input device 1210 may include any device that generates a signal representative of a sound, such as microphones, microphone arrays, or digital instruments (e.g., instruments having a musical instrument digital interface (MIDI) output).

Computing device 1200 may include a global positioning system (GPS) device 1209 (or corresponding interface circuitry, as discussed above). GPS device 1209 may be in communication with a satellite-based system and may receive a location of computing device 1200, as known in the art.

Computing device 1200 may include another output device 1205 (or corresponding interface circuitry, as discussed above). Examples include an audio codec, a video codec, a printer, a wired or wireless transmitter for providing information to other devices, or an additional storage device.

Computing device 1200 may include another input device 1211 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1200 may include a security interface device 1212. Security interface device 1212 may include any device that provides security measures for computing device 1200 such as intrusion detection, biometric validation, security encode or decode, managing access lists, malware detection, or spyware detection.

Computing device 1200, or a subset of its components, may have any appropriate form factor, such as a server or other networked computing component, a mobile device, a printer, a scanner, a monitor, a set-top box, an entertainment control unit, a vehicle control unit, a digital camera, a digital video recorder, or a wearable computing device.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that practice of the disclosed techniques and architectures is not limited to the embodiments so described but can be modified and altered without departing from the scope of the appended claims. For example, the above embodiments may include specific combinations of features as further provided below.

In first examples, an apparatus comprises one or more optical waveguides and a substrate under the optical waveguides. The substrate comprises a silicon layer and an insulator layer between the optical waveguides and the silicon layer. The insulator layer has a first thickness under a first longitudinal length of the waveguides and a second, greater, thickness under a second longitudinal length of the waveguides.

In second examples, for any of the first examples the insulator layer comprises predominantly silicon and oxygen and the second thickness is at least twice the first thickness.

In third examples, for any of the first through second examples the first thickness is less than 4 μm and the second thickness is greater than 4 μm.

In fourth examples, for any of the first through third examples the optical waveguides comprise substantially pure silicon within the first longitudinal length and the optical waveguides comprises predominantly silicon and nitrogen within the second longitudinal length.

In fifth examples, for any of the first through fourth examples the waveguides comprises a resonant optical mode cavity within the first longitudinal length, an optical gain medium is over the resonant optical mode cavity, and the second longitudinal length is external of the resonant cavity and the optical gain medium.

In sixth examples, for any of the first examples the insulator layer has the second thickness within a trench in the silicon layer, a depth of the trench varies periodically in a direction substantially orthogonal to the second longitudinal length, and the insulator layer has the first thickness around a perimeter of the trench.

In seventh examples, for any of the sixth examples an interface of the insulator layer and the trench comprises corrugations over the second longitudinal length, the second thickness varying within the corrugations.

In eighth examples, for any of the seventh examples the corrugations extend over the second longitudinal length and the interface of the insulator layer and the trench is substantially planar in a direction orthogonal to the second longitudinal length.

In ninth examples, for any of the first through eighth examples the waveguides have a transverse width less than 1 μm, and the second longitudinal length is at least 30 μm.

In tenth examples, a photonic integrated circuit (PIC) comprises a plurality of hybrid silicon lasers, each laser comprising a first optical waveguide length over a first area of a silicon substrate. The PIC comprises a plurality of output couplers, each coupler comprising a second optical waveguide length over a second area of the silicon substrate. The PIC comprises a third optical waveguide length extending over a third area of the silicon substrate and optically coupling the lasers with the output couplers. The first area of the silicon substrate comprises a silicon layer separated from the first optical waveguide length by a first thickness of material comprising silicon and oxygen. The second area of the silicon substrate comprises the silicon layer separated from the second optical waveguide length by a second thickness of material comprising silicon and oxygen. The second thickness is at least twice the first thickness.

In eleventh examples, for any of the tenth examples the second thickness is at least three times the first thickness.

In twelfth examples, for any of the tenth through eleventh examples an optical waveguide over the second optical waveguide length comprises predominantly silicon and nitrogen.

In thirteenth examples, for any of the tenth through twelfth examples an interface between the silicon layer and the second thickness of material comprising silicon and oxygen is corrugated over the second optical waveguide length.

In fourteenth examples, for any of the thirteenth examples a depth of corrugations within the silicon layer is at least 100 nm and less than 1 μm.

In fifteenth examples a method comprises receiving a substrate comprising a layer of dielectric material between a top silicon layer and a bottom silicon layer, the layer of dielectric material having a first thickness. The method comprises exposing a first region of the substrate by etching a region of the top silicon layer. The method comprises etching a plurality of features into the bottom silicon layer, the features separated by intervening regions of the bottom silicon layer. The method comprises forming dielectric material of a second thickness within the first region of the substrate by oxidizing the features. The method comprises forming a first length of an optical waveguide over the layer of dielectric material having the first thickness. The method comprises forming a second length of an optical waveguide over the dielectric material of the second thickness.

In sixteenth examples, for any of the fifteenth examples the method comprises etching the plurality of features comprises etching a plurality of substantially parallel trenches to a depth of at least 4 μm, and the features comprise ridges extending a longitudinal length between the trenches.

In seventeenth examples, for any of the sixteenth examples the longitudinal length between the trenches is substantially perpendicular to the second length of the optical waveguide.

In eighteenth examples, for any of the sixteenth through seventeenth examples oxidizing the features converts substantially all of the ridges into silicon dioxide, and oxidizing the features substantially fills the first region with silicon dioxide of a thickness of at least equal to the depth.

In nineteenth examples, for any of the eighteenth examples oxidizing the features leaves corrugations in the bottom silicon layer.

In twentieth examples, for any of the fifteenth through nineteenth examples the method comprises depositing a second dielectric material over the dielectric material of the second thickness, the second dielectric material comprising silicon and oxygen.

However, the above embodiments are not limited in this regard, and, in various implementations, the above embodiments may include the undertaking of only a subset of such features, undertaking a different order of such features, undertaking a different combination of such features, and/or undertaking additional features than those features explicitly listed. The scope of the disclosed techniques and architectures should therefore be determined with reference to the appended claims, along with the full scope of equivalents to which such claims are entitled.

What is claimed is:

1. An apparatus, comprising:
one or more optical waveguides; and
a substrate under the optical waveguides, wherein the substrate comprises a silicon layer and an insulator layer between the optical waveguides and the silicon layer, and wherein the insulator layer has a first thickness under a first longitudinal length of the waveguides and a second, greater, thickness under a second longitudinal length of the waveguides.

2. The apparatus of claim 1, wherein:
the insulator layer comprises predominantly silicon and oxygen; and
the second thickness is at least twice the first thickness.

3. The apparatus of claim 2, wherein the first thickness is less than 4 μm and the second thickness is greater than 4 μm.

4. The apparatus of claim 1, wherein the optical waveguides comprise substantially pure silicon within the first longitudinal length and the optical waveguides comprises predominantly silicon and nitrogen within the second longitudinal length.

5. The apparatus of claim 1, wherein:
the waveguides comprises a resonant optical mode cavity within the first longitudinal length;
an optical gain medium is over the resonant optical mode cavity; and
the second longitudinal length is external of the resonant cavity and the optical gain medium.

6. The apparatus of claim 1, wherein:
the insulator layer has the second thickness within a trench in the silicon layer;
a depth of the trench varies periodically in a direction substantially orthogonal to the second longitudinal length; and
the insulator layer has the first thickness around a perimeter of the trench.

7. The apparatus of claim 6, wherein an interface of the insulator layer and the trench comprises corrugations over the second longitudinal length, the second thickness varying within the corrugations.

8. The apparatus of claim 7, wherein the corrugations extend over the second longitudinal length and the interface of the insulator layer and the trench is substantially planar in a direction orthogonal to the second longitudinal length.

9. The apparatus of claim 1, wherein
the waveguides have a transverse width less than 1 μm; and
the second longitudinal length is at least 30 μm.

10. A photonic integrated circuit (PIC), comprising:
a plurality of hybrid silicon lasers, each laser comprising a first optical waveguide length over a first area of a silicon substrate;
a plurality of output couplers, each coupler comprising a second optical waveguide length over a second area of the silicon substrate; and
a third optical waveguide length extending over a third area of the silicon substrate and optically coupling the lasers with the output couplers, wherein:
the first area of the silicon substrate comprises a silicon layer separated from the first optical waveguide length by a first thickness of material comprising silicon and oxygen; and
the second area of the silicon substrate comprises the silicon layer separated from the second optical waveguide length by a second thickness of material comprising silicon and oxygen; and
the second thickness is at least twice the first thickness.

11. The PIC of claim 10, wherein the second thickness is at least three times the first thickness.

12. The PIC of claim 10, wherein an optical waveguide over the second optical waveguide length comprises predominantly silicon and nitrogen.

13. The PIC of claim 10, wherein an interface between the silicon layer and the second thickness of material comprising silicon and oxygen is corrugated over the second optical waveguide length.

14. The PIC of claim 13, wherein a depth of corrugations within the silicon layer is at least 100 nm and less than 1 μm.

15. A method comprising:
receiving a substrate comprising a layer of dielectric material between a top silicon layer and a bottom silicon layer, the layer of dielectric material having a first thickness;
exposing a first region of the substrate by etching an opening through the top silicon layer;
etching a plurality of features into the bottom silicon layer, the features separated by intervening regions of the bottom silicon layer;
forming dielectric material of a second thickness within the first region of the substrate by oxidizing the features;
forming a first length of an optical waveguide over the layer of dielectric material having the first thickness; and
forming a second length of an optical waveguide over the dielectric material of the second thickness.

16. The method of claim 15, wherein:
etching the plurality of features comprises etching a plurality of substantially parallel trenches to a depth of at least 4 μm; and
the features comprise ridges extending a longitudinal length between the trenches.

17. The method of claim 16, wherein the longitudinal length between the trenches is substantially perpendicular to the second length of the optical waveguide.

18. The method of claim 16, wherein:
oxidizing the features converts substantially all of the ridges into silicon dioxide; and
oxidizing the features substantially fills the first region with silicon dioxide of a thickness of at least equal to the depth.

19. The method of claim 18, wherein oxidizing the features leaves corrugations in the bottom silicon layer.

20. The method of claim 15, further comprising depositing a second dielectric material over the dielectric material of the second thickness, the second dielectric material comprising silicon and oxygen.
